(19) United States
(12) Patent Application Publication
(10) Pub. No.: US 2026/0043439 A1
(43) Pub. Date: Feb. 12, 2026

(54) OUTER RING FOR A WHEEL BEARING

(71) Applicant: AKTIEBOLAGET SKF, GOTEBORG (SE)

(72) Inventors: Volker WENDT, Üchtelhausen/Zell (DE); Padelis KATSAROS, Schweinfurt (DE); Karsten ZUHL, Lüchow (DE); Johannes Klaus ZANG, Schweinfurt (DE)

(21) Appl. No.: 19/284,892

(22) Filed: Jul. 30, 2025

(30) Foreign Application Priority Data
Aug. 6, 2024 (DE) 102024207410.1

(51) Int. Cl. F16C 33/58; F16C 19/38; F16C 33/36

(52) U.S. Cl. CPC F16C 33/58; F16C 19/38; F16C 33/366

(57) ABSTRACT

A wheel bearing outer ring configured to receive a double-row tapered roller bearing includes a first tapered ring portion having an induction-hardened first raceway on a radially inner surface, a second tapered ring portion having a induction-hardened second raceway on a radially inner surface, and at least one third ring portion axially adjoining the first tapered ring portion and having an induction hardened radially inner surface.

### CROSS-REFERENCE

This application claims priority to German patent application no. 10 2024 207 410.1 filed on Aug. 6, 2024, the contents of which are fully incorporated herein by reference.

### TECHNOLOGICAL FIELD

The present disclosure relates to an outer ring, which is intended for a wheel bearing and is formed to receive a double-row tapered roller bearing.

### BACKGROUND

Raceways of outer rings for wheel bearings are customarily hardened in order to withstand loads during operation. In normal induction hardening of raceways of such outer rings, the hardening region is concentrated on the zone of contact of the rolling elements. When the unit is subjected to high loads, as is often the case with lorry (truck) wheel bearing units, the permissible load on the bearing is primarily limited by the structural strength of the housing/hub construction. The outer rings of these lorry wheel bearings are typically produced from forged carbon steel and are designed for a maximum bearing load. If, then, the supported impact load is to be increased, the thickness of the outer ring of the forged part, i.e. of the outer ring of the wheel bearing or the wheel hub formed as an outer ring, has hitherto been increased. However, this requires a new set of forging tools and the use of more material, which makes it more expensive to produce a wheel bearing.

### SUMMARY

It is therefore an aspect of the present disclosure to provide an outer ring, which is cost-effective to produce, for a wheel bearing.

The outer ring is formed to receive a double-row tapered roller bearing, wherein the outer ring has a first tapered ring portion, on the inner side of which a first induction-hardened raceway for a first set of tapered rollers is formed. Furthermore, the outer ring has a second tapered ring portion, on the inner side of which a second induction-hardened raceway for a second set of tapered rollers is formed. Particularly when used as a wheel bearing arrangement, it is customary to employ double-row roller bearings, which can support a particularly high load. In this case, tapered roller bearings are preferred, in particular in the heavy-duty vehicle industry (lorry industry).

In order, then, to be able to withstand higher loads in comparison with previous outer rings for wheel bearings, the outer ring disclosed herein for a wheel bearing has at least one third ring portion which adjoins the first ring portion in the axial direction, wherein the inner side of the at least one third ring portion joined to the raceway is induction-hardened. This induction-hardened region adjoining the first ring portion, i.e. the induction-hardened raceway, lengthens the induction-hardened region as a whole. In comparison with previous outer rings, this allows more material to be converted from the normal low strength properties of the material of the outer ring (in particular forged steel) to the high strength properties of a normally martensitically hardened raceway. The enlargement of this greatly improved region of heat-treated steel on one or even both sides adjacent to the induction-hardened raceway helps to bear a higher external bearing load without changing the shape and thickness of the forged outer ring.

Furthermore, to produce this enlarged induction-hardened region, it is sufficient to change the shape of the inductor used. This is considerably more cost-effective than providing new forging tools and increasing the amount of material used.

In addition, in comparison with outer rings which are intended for wheel bearings and the material thickness of which has been increased in order to withstand higher loads, it is not necessary to increase the material thickness of the outer ring described herein for wheel bearings. Therefore, firstly, the weight of the outer ring is not increased and can thus remain at the level of previous standard wheel hubs. Furthermore, it is not necessary to use more material, in particular forged steel, for the wheel bearing unit, meaning that material costs are not increased.

According to a further embodiment, the outer ring for a wheel bearing has a flange at one axial end, wherein the second tapered ring portion is arranged at the axial end of the outer ring having the flange, and wherein the first tapered ring portion and the at least one third ring portion are arranged at the axial end of the outer ring opposite the flange. The flange is formed to fasten the outer ring to a component.

According to a further embodiment, the at least one third ring portion comprises a first third ring portion and a second third ring portion, wherein the first third ring portion and the second third ring portion adjoin the first tapered ring portion on both sides in the axial direction. By surrounding the first tapered ring portion on both sides with the first and second further hardened ring portions, the hardened region as a whole in these portions is increased, giving it a shell-like appearance.

The first third ring portion may extend from the first tapered ring portion to an axial end of the outer ring. This axial end is located opposite the end of the outer ring with the flange. The outer ring is therefore hardened in its axial extent up to this axial end, which increases the load-bearing capacity of the outer ring and therefore the load-bearing capacity of the wheel bearing, in particular in this region.

Furthermore, the second third ring portion may extend from the first tapered ring portion towards the centre of the outer ring in the axial direction, wherein the axial span of the second third ring portion corresponds to ¼ to ⅓ of the length of the raceway of the first tapered ring portion.

The dimensions of the axial span with regard to the intermediate region may be selected in accordance with the distance between the inductively hardened raceways. The second raceway, which is customarily hardened in a second step, may be affected by the hardening of the second third ring portion if the latter reaches too close to the second raceway. To prevent this, the axial span of ¼ to ⅓ may thus be selected in such a way that the region of the second raceway is not affected by heat.

According to a further embodiment, the total induction-hardened region, formed by the induction-hardened regions of the first tapered ring portion, the first third ring portion and the second third ring portion, is 50% to 60%, in particular 52% to 55%, greater than the induction-hardened region of the first tapered ring portion. The total hardened region around the first raceway is 50% to 60%, in particular 52% to 55%, greater in comparison with previous standard outer rings in which only the first raceway was hardened. An increase or decrease in the percentage may be achieved, for example, by a correspondingly higher or lower hardening depth. Alternatively, an increase or decrease in the percentage may be achieved by a correspondingly lower or higher wall thickness of the outer ring while maintaining the same hardening depth. A combination of these two variants is also possible.

In comparison with standard wheel bearings, a higher total proportion of the highly loaded load region of the inboard side of the outer ring of the wheel bearing, i.e. the end of the outer ring opposite the flange, is thus converted from the basic state of forged steel to a hardened state, resulting in increased robustness of the wheel bearing as a whole.

According to a further embodiment, an intermediate portion between the second tapered ring portion and the at least one third ring portion is unhardened. This unhardened intermediate portion may, for example, be present if the hardening of the second raceway on one side and the hardening of the first raceway and the ring portions adjacent thereto are carried out separately.

According to a further embodiment, the at least one third ring portion is arranged in the region of a seal of the tapered roller bearing. In this manner, the region of the seal may be reinforced, which prevents or at least reduces deformations in the outer ring in this region. This contributes in turn to a secure fit of the seal.

According to a further embodiment, the at least one third ring portion is arranged in the region of an ABS ring of the tapered roller bearing. Such an ABS ring is arranged on the outer circumference of the outer ring. However, since the outer ring is hardened in the region of the ABS ring on the inner side of the outer ring according to this embodiment, the region of the ABS ring is therefore reinforced. It is therefore also possible in this case to reduce deformations in the outer ring in this region, which likewise makes it possible to prevent or at least reduce the relative movement of the ABS ring.

The at least one third ring portion or its hardened surface may also extend along the surface of the end face of the outer ring. In this manner, the hardening zone may reach into the fitting region of the ABS ring. This may further improve the increase in hardness in this region and therefore further reduce deformations. It is therefore possible to further reduce or avoid the relative movement of the ABS ring or the loosening of the ABS ring.

Further advantages and advantageous embodiments are specified in the description, the drawings and the claims. In particular, the combinations of features specified in the description and in the drawings are provided purely by way of example, and therefore the features may also be present individually or in other combinations.

### BRIEF DESCRIPTION OF THE DRAWINGS

FIG. 1 is a perspective cross-sectional view of an outer ring for a wheel bearing according to an embodiment of the present disclosure.

FIG. 2 is a perspective cross-sectional view of a conventional outer ring for a wheel bearing unit.

FIG. 3 is a perspective view of a wheel bearing including the outer ring of FIG. 1.

### DETAILED DESCRIPTION

The disclosure is to be described in more detail in the following with reference to exemplary embodiments illustrated in the drawings. The exemplary embodiments and the combinations shown in the exemplary embodiments are provided purely by way of example and are not intended to establish the scope of protection of the invention which is defined solely by the appended claims. In the following, identical or functionally equivalent elements are denoted with the same reference signs.

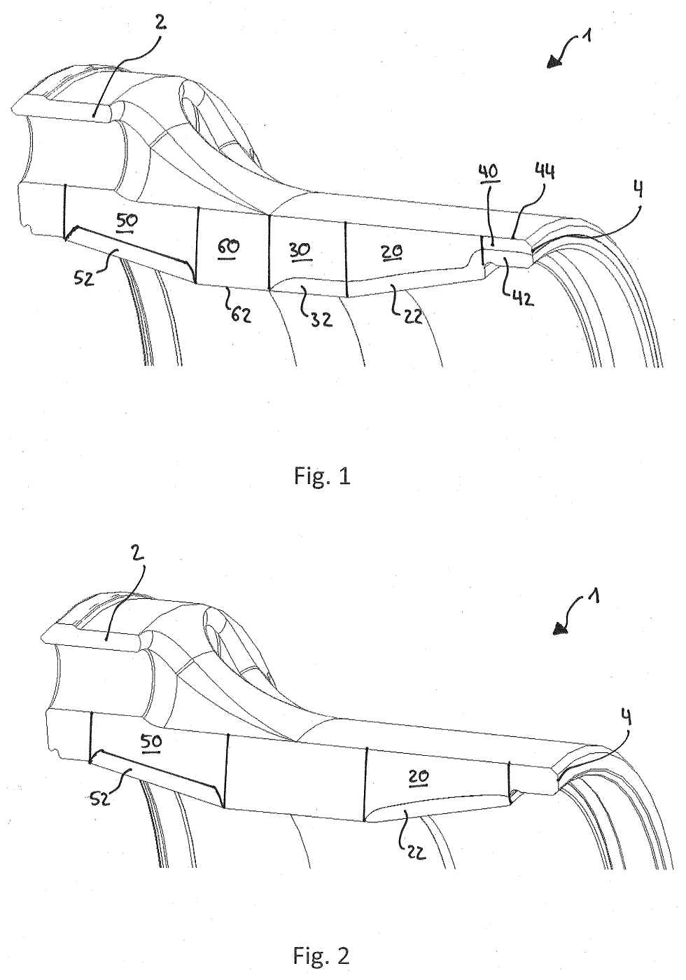

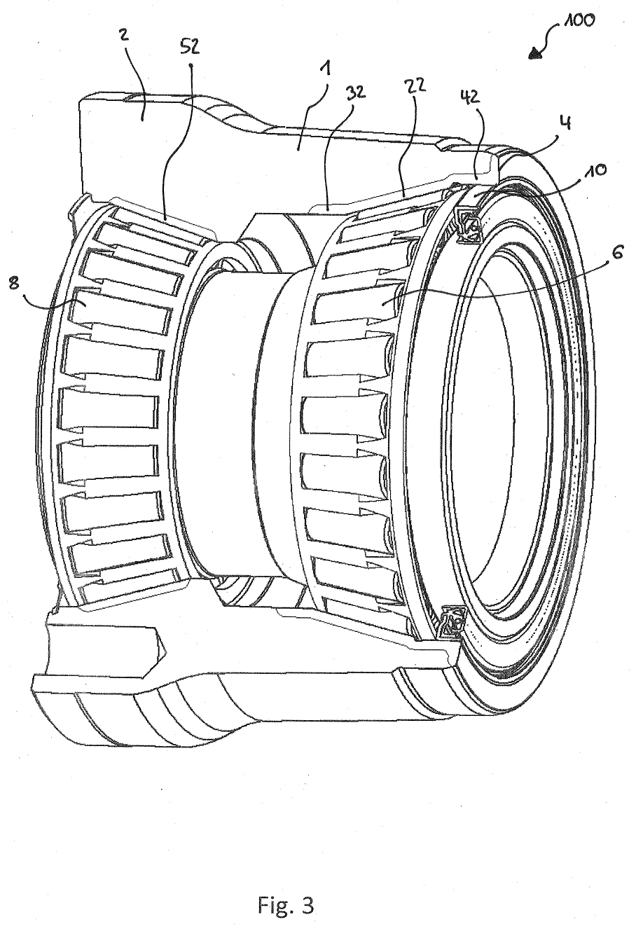

FIG. 1 shows an outer ring 1 for a wheel bearing 100, as shown in FIG. 3. The outer ring 1 may be formed from steel, for example forged steel. The outer ring 1 has two raceways for receiving a double-row tapered roller bearing. For this purpose, the outer ring 1 has a first tapered ring portion 20, on the radially inner side of which a first induction-hardened raceway 22 for a first set of tapered rollers (6 in FIG. 3) is formed. Furthermore, the outer ring 1 has a second tapered ring portion 50, on the radially inner side of which a second induction-hardened raceway 52 for a second set of tapered rollers (8 in FIG. 3) is formed.

Such an outer ring, serving as the outer ring of a double-row tapered roller, is particularly suitable for use in lorries in particular, since tapered rollers offer good load capacity and load distribution. The outer ring 1 shown herein can thus withstand the loads which arise during operation.

At one axial end, the outer ring 1 has a flange 2, wherein the second tapered ring portion 50 is arranged at the axial end of the outer ring 1 having the flange 2. The first tapered ring portion 20 is arranged at the axial end of the outer ring 1 opposite the flange 2.

Hitherto, such an outer ring 1 has been provided with two induction-hardened raceways 22, 52, as shown in FIG. 2. In order to withstand higher loads, it was possible to produce this outer ring with a greater material thickness. However, this had the disadvantage that, on the one hand, more material was required, leading to higher material costs and, on the other hand, different forging tools were required, leading in turn to higher production costs. In addition, a greater material thickness leads to more weight, which is not always desirable.

In contrast, the outer ring 1 shown in FIG. 1 has, in addition to the induction-hardened raceways 22, 52, at least a first third ring portion ring portion 30, 40, which adjoins the first ring portion 20 in the axial direction, wherein the inner side 32, 42 of the at least one further ring portion 30, 40 is induction-hardened. Although an induction-hardened inner side 32, 42 is provided on both axial sides of the first ring portion 20 in FIG. 1, it also is possible for the inner side of the ring portions 30, 40 to be hardened only on one axial side of the first ring portion 20.

Since the first induction-hardened raceway 22 is axially lengthened in this manner (in one or both axial directions), the outer ring 1 is able to withstand higher loads without requiring a greater material thickness. In comparison with conventional outer rings, as shown in FIG. 2, the total proportion of the induction-hardened material is increased. As a result, the outer ring 1 can withstand higher loads.

The first further ring portion 40 preferably extends from the first tapered ring portion 20 to an axial end 4 of the outer ring 1. This has the advantage that the outer ring 1 is hardened in the region of a seal 10 of the wheel bearing 100, as shown in FIG. 3. As a result, the outer ring 1 is more stable and deformations are avoided. This in turn leads to a better fit of the seal 10.

An ABS ring (not shown) may be arranged on an outer side 44 of the first further ring portion 40. Since the inner side 42 of the first further ring portion 40 may be hardened, the first further ring portion 40 as a whole becomes more stable as a result, which also renders the fastening of the ABS ring more stable. In particular, owing to the induction-hardened inner side 42, deformations in the first further ring portion 40 are reduced, which can prevent the ABS ring from becoming loose. The hardened inner side 42 of the first further ring portion 40 may also extend up to an end face of the axial end 4 of the outer ring 1, as shown in FIG. 3. In this manner, the outer ring 1, and particularly the first further ring portion 40, are rendered even more stable and deformations are prevented even more effectively.

The second further ring portion 30, which extends from the first tapered ring portion 20 towards the centre of the outer ring 1 in the axial direction, may have an axial span which corresponds to ¼ to ⅓ of the length of the raceway 22 of the first tapered ring portion 20.

An intermediate portion 60 is provided between the second tapered ring portion 50 and the second further ring portion 30. The inner side 62 of this intermediate portion 60 is unhardened.

In summary, an outer ring of a wheel bearing is provided, this outer ring having a higher proportion of hardened material in comparison with previous outer rings of wheel bearings. In this manner, a more stable wheel bearing is provided, which can withstand higher loads without, however, having to increase the material thickness of the outer ring, as has previously been the case.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing outer rings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE SIGNS

1 Outer ring
2 Flange
4 End of the outer ring opposite the flange
6 First set of tapered rollers
8 Second set of tapered rollers
10 Seal
20 First tapered ring portion
22 First induction-hardened raceway
30 Second further ring portion
32 Induction-hardened inner side
40 First further ring portion
42 Induction-hardened inner side
44 Outer side of the first further ring portion
50 Second tapered ring portion
52 Second induction-hardened raceway
60 Intermediate portion
62 Unhardened region
100 Wheel bearing

What is claimed is:

1. A wheel bearing outer ring configured to receive a double-row tapered roller bearing, comprising:
a first tapered ring portion having an induction-hardened first raceway on a radially inner surface,
a second tapered ring portion having a induction-hardened second raceway on a radially inner surface, and
at least one third ring portion axially adjoining the first tapered ring portion and having an induction hardened radially inner surface.

2. The wheel bearing outer ring according to claim 1,
including a fourth ring portion between the first tapered ring portion and the second tapered ring portion having a radially inner surface that is not induction hardened.

3. The wheel bearing outer ring according to claim 2,
wherein the fourth ring portion has a cylindrical inner surface.

4. The wheel bearing outer ring according to claim 3,
wherein the outer ring has a flange at a first axial end,
wherein the second tapered ring portion is arranged at the first axial end, and
wherein the first tapered ring portion and the at least one third ring portion are arranged at a second axial end of the outer ring opposite the first axial end of the outer ring.

5. The wheel bearing outer ring according to claim 4,
wherein the at least one third ring portion comprises a first third ring portion and a second third ring portion, and
wherein the first third ring portion is located between the first tapered ring portion and the second axial end and the second third ring portion is located between the first tapered ring portion and the second tapered ring portion.

6. The wheel bearing outer ring according to claim 5,
wherein the first third ring portion extends from the first tapered ring portion to the second axial end of the outer ring.

7. The wheel bearing outer ring according to claim 6,
wherein the second third ring portion extends from the first tapered ring portion to the fourth ring portion, and
wherein an axial length of the second third ring portion is ¼ to ⅓ of a length of the raceway of the first tapered ring portion.

8. The wheel bearing outer ring according claim 6,
wherein a total induction-hardened area, comprising a sum of areas of the first raceway, the second raceway and the at least one third ring portion is 50% to 60% greater than the area of the induction-hardened first raceway.

9. The wheel bearing outer ring according claim 6,
wherein a total induction-hardened area, comprising a sum of the areas of the first raceway, the second raceway and the at least one third ring portion is 52% to 55% greater than the area of the induction-hardened first raceway.

10. The wheel bearing outer ring according claim 6,
wherein the at least one third ring portion is arranged a the region of a seal of the tapered roller bearing.

11. The wheel bearing outer ring according claim 6,
wherein the at least one third ring portion is arranged a the region of an ABS ring of the tapered roller bearing.

12. The wheel bearing outer ring according to claim 1,
including at least one fourth ring portion between the first tapered ring portion and the second tapered ring portion having a cylindrical radially inner surface that is not induction hardened,
wherein the wheel bearing outer ring includes a first axial end having a flange and a second axial end axially spaced from the first axial end,
wherein the at least one third ring portion comprises a first third ring portion and a second third ring portion,
wherein at least part of the second tapered ring portion is located radially inward of the flange,
wherein the fourth ring portion is axially adjacent to the second tapered ring portion,
wherein the second third ring portion is axially adjacent to the fourth ring portion,
wherein the first tapered ring portion is axially adjacent to the second third ring portion,
wherein the first third ring portion is axially adjacent to the first tapered ring portion and extends to the second axial end, and
wherein a minimum diameter of the first third ring portion is greater than a maximum diameter of the first tapered ring portion.
